(19) United States
(12) Patent Application Publication
(10) Pub. No.: US 2021/0023790 A1
(43) Pub. Date: Jan. 28, 2021

(54) CONTROL OF USED BUILD MATERIAL PARTICLE RECLAMATION OPERATIONS

(71) Applicant: Hewlett-Packard Development Company, L.P., Spring, TX (US)

(72) Inventors: Joshua R. SCHMALE, Vancouver, WA (US); Philip J. STALLBAUMER, Vancouver, WA (US)

(73) Assignee: Hewlett-Packard Development Company, L.P., Spring, TX (US)

(21) Appl. No.: 16/520,158

(22) Filed: Jul. 23, 2019

(51) Int. Cl. B29C 64/357; B29C 64/307; B29C 64/386; B29B 17/00

(52) U.S. Cl. CPC B29C 64/357; B29C 64/307; B33Y 50/00; B29B 17/0005; B29C 64/386

(57) ABSTRACT

According to examples, a processor of an apparatus may access a plurality of measurement values corresponding to build material particles reclaimed from a build chamber during a period of time in which a reclamation operation is performed. The plurality of measurement values may be determined at a first hopper of the reclaimed build material particles as the build material particles are reclaimed from the build chamber and received into the first hopper. The processor may also calculate variances among the plurality of measurement values, determine whether a calculated variance of the calculated variances falls below a predetermined threshold value, and based on a determination that the calculated variance falls below the predetermined threshold value, stop the reclamation operation.

### BACKGROUND

In three-dimensional (3D) printing, an additive printing process may be implemented to fabricate three-dimensional solid parts from a digital model. 3D printing may be used in rapid product prototyping, mold generation, mold master generation, and manufacturing. Some 3D printing techniques are considered additive processes because they involve the application of successive layers of material to an existing surface (template or previous layer). This is unlike traditional machining processes, which often rely upon the removal of material to create the final part. 3D printing may involve curing of a binding agent or fusing of the building material, which for some materials may be accomplished using heat-assisted melting, fusing, sintering, curing, or otherwise coalescing, and then solidification, and for other materials may be performed through UV curing of polymer-based build materials or UV or thermally curable agents.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may stop a reclamation operation of reclaimed (or equivalently, unused) build material particles from a build chamber of a 3D fabrication system;

FIG. 2 shows a block diagram of an example 3D fabrication system in which a processor of the example apparatus depicted in FIG. 1 may control activation and deactivation of a reclamation system of the 3D fabrication system;

FIG. 3 shows a diagram of an example filtering process in which the processor depicted in FIGS. 1 and 2 may filter out some of the accessed measurement values;

FIG. 4 depicts a flow diagram of an example method for controlling an operation of a reclamation system in a 3D fabrication system; and

FIG. 5 shows a block diagram of an example 3D fabrication system in which the apparatus and processor depicted in FIGS. 1 and 2 may control activation and deactivation of a reclamation system of the 3D fabrication system.

### DETAILED DESCRIPTION

In many types of 3D printing operations, build material particles may selectively be joined and/or fused together to form a 3D object. The 3D object may be fabricated in a build chamber from a plurality of successively formed layers of build material, and not all of the build material particles may be used to fabricate the 3D object. In these instances, a reclamation operation may be performed to remove the unused build material particles from the build chamber. Disclosed herein are apparatuses, 3D fabrication systems, and methods for controlling the reclamation operation of the unused build material particles from a build chamber of a 3D fabrication system. Particularly, a processor may cause a reclamation system that performs the reclamation operation to be deactivated based on a determination by the processor that little or no additional unused build material particles are being removed from the build chamber. That is, the processor may determine changes in a measured value of a hopper into which the unused build material particles may be supplied and when the values of the determined changes fall below a predetermined threshold value, the processor may deactivate the reclamation system.

Through implementation of the apparatuses, 3D fabrication systems, and methods disclosed herein, the processor may automatically deactivate the reclamation system upon or shortly after the processor determines that the attribute value at a hopper or the combined attribute values at multiple hoppers has stopped changing beyond some threshold value. In this regard, the processor may base the decision to stop the reclamation system on the changing values of the attributes and not a total weight of the unused build material particles collected in the hopper or hoppers as the total weight of the unused build material particles contained in the build chamber following a 3D fabrication operation may be difficult to determine. In any case, by stopping the reclamation system upon or shortly after the determination is made that additional unused build material particles may not be removed from the build chamber, the amount of power consumed by the reclamation system may be reduced, e.g., minimized. For similar reasons, the amount of wear and tear on the reclamation system may be reduced, e.g., minimized, and the duration of time in which the reclamation operation is performed may be reduced, e.g., minimized.

Before continuing, it is noted that as used herein, the terms “includes” and “including” mean, but is not limited to, “includes” or “including” and “includes at least” or “including at least.” The term “based on” means “based on” and “based at least in part on.”

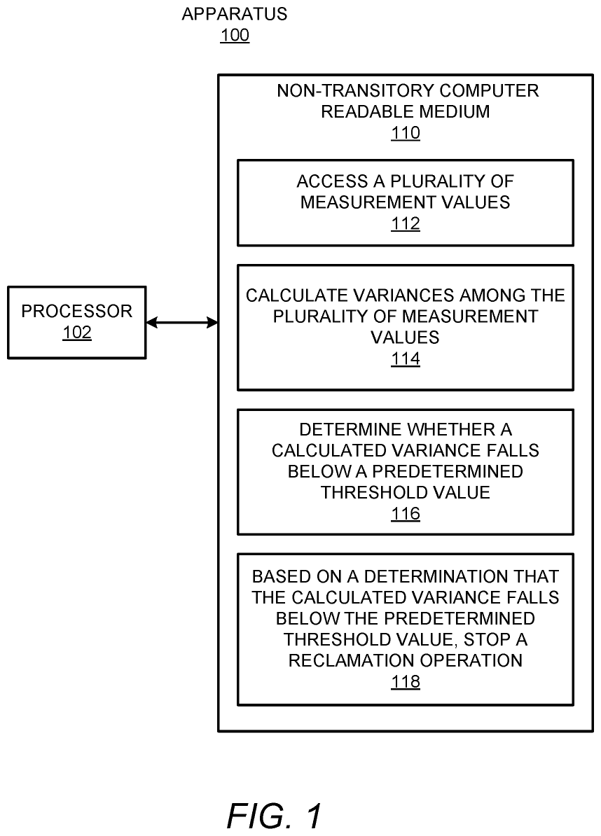

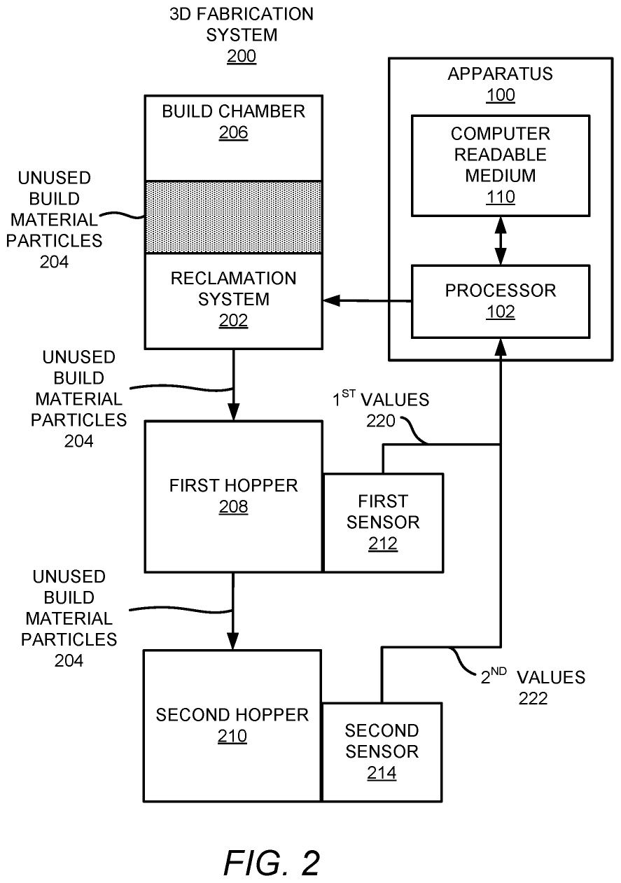

Reference is first made to FIGS. 1 and 2. FIG. 1 depicts a block diagram of an example apparatus 100 that may stop a reclamation operation of reclaimed (or equivalently, unused) build material particles from a build chamber of a 3D fabrication system. FIG. 2 depicts a block diagram of an example 3D fabrication system 200 in which a processor 102 of the example apparatus 100 depicted in FIG. 1 may control activation and deactivation of a reclamation system 202 of the 3D fabrication system 200. It should be understood that the example apparatus 100 depicted in FIG. 1 and the example 3D fabrication system 200 depicted in FIG. 2 may include additional features and that some of the features described herein may be removed and/or modified without departing from the scopes of the apparatus 100 or the 3D fabrication system 200.

The apparatus 100 may be a computing device, a server computer, a laptop computer, or the like. In other examples, the apparatus 100 may be part of the 3D fabrication system 200 as shown in FIG. 2. In any of these examples, the apparatus 100 may control operations of the 3D fabrication system 200 to, for instance, control a reclamation system 202 in removing unused build material particles 204 from a build chamber 206 and delivering the unused build material particles 204 into a first hopper 208. Particularly, the apparatus 100 may automatically stop, e.g., deactivate, the reclamation system 202 based on a determination that the first hopper 208 has stopped receiving additional unused build material particles 204 or the flow of the unused build material particles 204 into the first hopper 208 and has nearly stopped. In some examples, the apparatus 100 may automatically stop the reclamation system 202 based on a determination the flow of the unused build material particles 204 into a combination of the first hopper 208, a second hopper 210, and/or an additional hopper, as a whole has stopped or has nearly stopped.

In some examples, the processor 102 may activate the reclamation system 202 to perform a reclamation operation following the fabrication of a 3D object (not shown) from build material particles supplied into the build chamber 206. For instance, portions of the 3D object may be formed by binding and/or fusing build material particles in selective areas of successive layers of the build material particles as discussed herein. Following formation of the 3D object, the 3D object may be removed from the build chamber 206 such that unused build material particles 204, e.g., build material particles that were not bound or fused together to form part of the 3D object, may remain in the build chamber 206. In other examples, the unused build material particles 204 may be removed from the build chamber 206 such that the 3D object remains in the build chamber 206.

As shown in FIG. 2, the reclamation system 202 may cause the unused build material particles 204 to be removed from the build chamber 206 and supplied into the first hopper 208. In some examples, the reclamation system 202 may include a vibration motor, a pump, and/or other components for use in reclaiming the unused build material particles 204 from the build chamber 206. The vibration motor may vibrate the build chamber 206 to cause the unused build material particles 204 to, for instance, remove the unused build material particles 204 from the 3D object and/or to better flow out of the build chamber 206. The pump, which may be a blower, may cause air and the unused build material particles 204 to flow from the build chamber 206 and in the direction of the first hopper 208 via a conduit between the build chamber 206 and the first hopper 208. In some examples, the first hopper 208 may store all of the unused build material particles 204 received from the build chamber 206. In other examples, for instance, in instances in which the first hopper 208 may not be of sufficient size to hold all of the unused build material particles 204, the unused build material particles 204 may flow from the first hopper 208 to the second hopper 210. Thus, for instance, during a reclamation operation, some of the unused build material particles 204 may be in the first hopper 208 and some of the unused build material particles 204 may be in the second hopper 210.

As also shown in FIG. 2, a first sensor 212 may be positioned to detect a measurement value (or equivalently, an attribute value), of the first hopper 208. Likewise, a second sensor 214 may be positioned to detect a measurement value of the second hopper 210. In some examples, the first sensor 212 and the second sensor 214 may each be a weight measurement sensor, such as a load cell or the like, that may detect a weight of the first hopper 208 or the second hopper 210, respectively. In these examples, the first sensor 212 may continuously, e.g., at set intervals of time, detect the increasing weight of the first hopper 208 as the unused build material particles 204 are supplied into the first hopper 208. The first sensor 212 may also continuously, e.g., at set intervals of time, detect the decreasing weight of the first hopper 208 as the unused build material particles 204 are removed from the first hopper 208 and supplied to the second hopper 210.

Similarly, the second sensor 214 may continuously, e.g., at set intervals of time, detect the increasing weight of the first hopper 208 as the unused build material particles 204 are supplied into the first hopper 208. In addition, the first sensor 212 may communicate detected first values 220 (measurement values, attribute values, or the like) to the processor 102 and/or the second sensor 214 may communicate detected second values 222 (measurement values, attribute values, or the like) to the processor 102. As discussed herein, the processor 102 may process the first values 220 and/or the second values 222 to determine when to deactivate the reclamation system 202.

In addition, or alternatively, the first sensor 212 and the second sensor 214 may be other types of sensors. For instance, the first sensor 212 and/or the second sensor 214 may be pressure sensors. In these examples, the first sensor 212 may continuously, e.g., at set intervals of time, detect the increasing pressure inside the first hopper 208 as the unused build material particles 204 are supplied into the first hopper 208. Similarly, the second sensor 214 may continuously, e.g., at set intervals of time, detect the increasing pressure of the first hopper 208 as the unused build material particles 204 are supplied into the first hopper 208. In addition, the first sensor 212 may communicate detected first values 220 (measurement values, attribute values, or the like) to the processor 102 and/or the second sensor 214 may communicate detected second values 222 (measurement values, attribute values, or the like) to the processor 102.

Although particular reference is made herein to the 3D fabrication system 200 including a single first hopper 208 or two hoppers 208, 210, it should be understood that the 3D fabrication system 200 may include any number of hoppers. For instance, the unused build material particles 204 may additionally or alternatively be moved from the first hopper 208 to a third hopper (not shown). As discussed herein, the processor 102 may also include measurement values of the third hopper in determining when to deactivate the reclamation system 202. The hoppers may also include supply units in some examples.

With reference to FIGS. 1 and 2, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a non-transitory computer readable medium 110 that may have stored thereon machine-readable instructions 112-118 (which may also be termed computer readable instructions) that the processor 102 may execute. The non-transitory computer readable medium 110 may be an electronic, magnetic, optical, or other physical storage device that includes or stores executable instructions, where the term “non-transitory” does not encompass transitory propagating signals. The non-transitory computer readable medium 110 may be, for example, Random Access memory (RAM), an Electrically Erasable Programmable Read-Only Memory (EEPROM), a storage device, an optical disc, and the like. The non-transitory computer readable medium 110 may also be referred to as a memory.

In some examples, instead of the non-transitory computer readable medium 110, the apparatus 100 may include hardware logic blocks that may perform functions similar to the instructions 112-118. In yet other examples, the apparatus 100 may include a combination of instructions and hardware logic blocks to implement or execute functions corresponding to the instructions 112-118. In any of these examples, the processor 102 may implement the hardware logic blocks and/or execute the instructions 112-118. As discussed herein, the apparatus 100 may also include additional instructions and/or hardware logic blocks such that the processor 102 may execute operations in addition to or in place of those discussed herein with respect to FIGS. 1 and 2.

The processor 102 may fetch, decode, and execute the instructions 112 to access a plurality of measurement values 220 corresponding to unused build material particles 204 reclaimed from a build chamber 206, for instance, during a period of time in which a reclamation operation is performed. The plurality of measurement values 220 may also be termed detected attribute values herein. In any regard, the first sensor 212 may detect the measurement values 220 at the first hopper 208 as the unused build material particles 204 are supplied into the first hopper 208 and the processor 102 may receive the detected measurement values 220 from the first sensor 212. In other examples, the detected measurement values 220 may be stored in a data store (not shown) and the processor 102 may access the detected measurement values 220 from the data store.

The processor 102 may fetch, decode, and execute the instructions 114 to calculate variances among the plurality of measurement values 220. That is, the processor 102 may calculate variances, e.g., changes, in the measurement values 220 over the period of time during which the reclamation system 202 performs the reclamation operation. According to examples, the first sensor 212 may continuously detect the measurement values 220 and may continuously, e.g., at set intervals of time, communicate the detected measurement values 220 for access by the processor 102. In these examples, the processor 102 may access the measurement values 220 as the measurement values 220 are determined continuously over the period of time. In addition, the processor 102 may calculate the variances as the measurement values 220 are accessed over the period of time.

The processor 102 may fetch, decode, and execute the instructions 116 to determine whether a variance of the calculated variances falls below a predetermined threshold value. The predetermined threshold value may be a user defined value and may have been determined based on testing, prior operations, modeling, and/or like. In any regard, the predetermined threshold value may be a value that may correspond to an indication that little or no unused build material particles 204 are being removed from the build chamber 206. In other words, the predetermined threshold value may correspond to a value that may indicate that most or all of the unused build material particles 204 have been removed from the build chamber 206.

The processor 102 may fetch, decode, and execute the instructions 118 to, based on a determination that the calculated variance falls below the predetermined threshold value, stop the reclamation operation. That is, the processor 102 may stop the reclamation system 202, e.g., deactivate the vibration motor and/or pump of the reclamation system 202, based on a determination that the calculated variance falls below the predetermined threshold value. In other examples, however, the processor 102 may wait to stop the reclamation system 202 until the processor 102 determines that a certain number of consecutive variances falls below the predetermined threshold value. The certain number may include, for instance, from about two to about five consecutive variances falling below the predetermined threshold value.

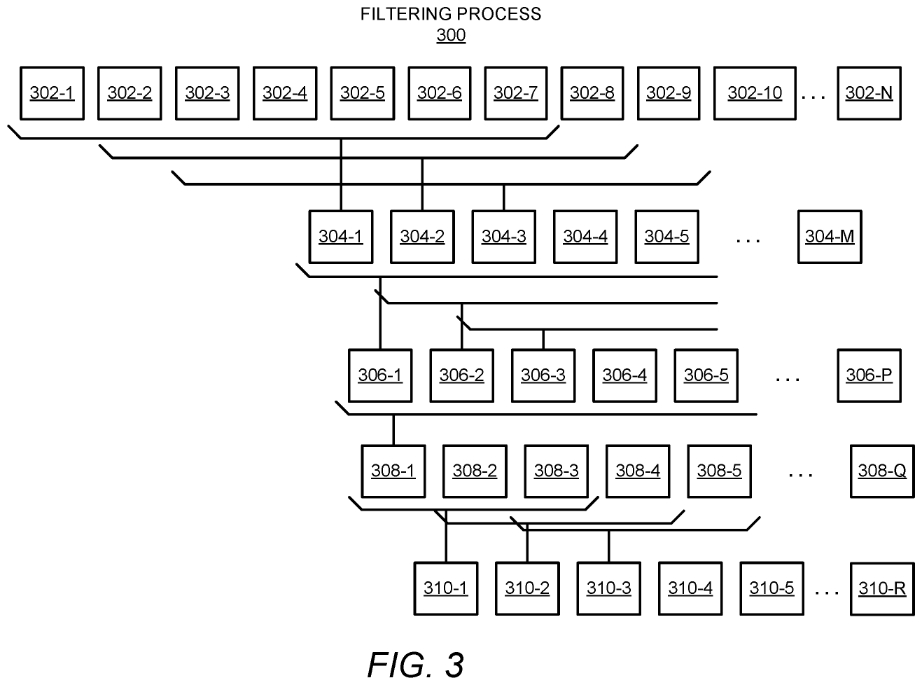

According to examples, the processor 102 may perform a filtering process on the measurement values 220 to reduce noise in the measurement values 220 and thus more accurately determine when the reclamation system 202 is to be stopped. That is, for instance, the processor 102 may filter out some of the accessed measurement values 220 and may determine the variances among the remaining measurement values 220. Reference is made to FIG. 3, which shows a diagram of an example filtering process 300 in which the processor 102 may filter out some of the accessed measurement values 220. It should be understood that the example filtering process 300 depicted in FIG. 3 is merely an example and should thus not be construed as limiting the present disclosure. In the description of FIG. 3, it should be noted that each of the variables “N,” “M,” “P,” “Q,” and “R” may represent a value greater than one and may also represent different values with respect to each other.

In FIG. 3, reference numerals 302-1 to 302-N may represent the accessed measurement values 220, which may have been detected over a certain period of time. The reference numerals 302-1 to 302-N may alternatively represent sums of the access measurement values 220, 222. Thus, the description of the measurement values 220 with respect to FIG. 3 should also be understood to correspond to a sum of the measurement values 220, 222 as discussed herein.

In examples, the processor 102 may, for each of a rolling set of the measurement values 220, select a measurement value 304-1 having a predefined rank among the rolling set. That is, for instance, each of the rolling set of measurement values 220 may include a certain number of measurement values 220, e.g., five, seven, nine, or the like. In the example shown in FIG. 3, the rolling set of measurement values 220 may include seven measurement values and thus, a first rolling set may include the measurement values 220 corresponding to reference numerals 302-1 to 302-7, a second rolling set may include the measurement values 220 corresponding to reference numerals 302-2 to 302-8, and so forth. In addition, for the first rolling set of measurement values, the processor 102 may determine the measurement value 304-1 that corresponds to a predefined rank among the first rolling set. The predefined rank may be, for instance, the fifth highest value, the sixth highest value, or the like. The processor 102 may determine the respective measurement values 304-2 to 304-M corresponding to the predefined rank for each of the respective rolling sets of measurement values in similar manners.

The processor 102 may also, for each of a rolling set of measurement values 304-1 to 304-M having the predefined rank, determine an average 306-1 to 306-P. That is, for instance, each of the rolling set of measurement values 304-1 to 304-M having the predefined rank may include a certain number of measurement values 220, e.g., five, seven, nine, or the like. In the example shown in FIG. 3, the rolling set of measurement values 304-1 to 304-M may include seven measurement values having the predefined rank and thus, a first rolling set may include the measurement values 220 corresponding to reference numerals 304-1 to 304-7, a second rolling set may include the measurement values 220 corresponding to reference numerals 304-2 to 304-8, and so forth. In addition, the processor 102 may determine a first average value 306-1 for the measurement values 304-1 to 304-7 in the first rolling set of measurement values 304-1 to 304-7 having the predefined rank, a second average value 306-2 for the measurement values 304-2 to 304-8 in the second rolling set, and so forth. In this regard, the processor 102 may determine a moving average of the measurement values 304-1 to 304-M having the predefined rank in their respective rolling sets.

The processor 102 may further, for each of a rolling set of averages 306-1 to 306-P, determine a variance 308-1 to 308-Q. That is, for instance, each of the rolling set of averages 306-1 to 306-P may include a certain number of the averages 306-1 to 306-P, e.g., five, seven, nine, or the like. In the example shown in FIG. 3, the rolling set of averages 306-1 to 306-9 may include seven averages and thus, a first rolling set may include the averages 306-1 to 306-7, a second rolling set may include the averages 306-2 to 306-8, and so forth. In addition, the processor 102 may determine a first variance 308-1 of the averages 306-1 to 306-7 in the first rolling set of averages, a second variance 308-2 for the averages 306-2 to 306-8 in the second rolling set, and so forth. The processor 102 may determine the variances 308-1 to 308-Q as the average values of the squared differences from the mean of the respective averages 306-1 to 306-P in the respective rolling sets of averages.

The processor 102 may still further, for each of the determined variances 308-1 to 308-Q, determine whether the variance 308-1 to 308-Q falls below the predetermined threshold value. In addition, or alternatively, as shown in FIG. 3, the processor 102 may determine whether a certain rolling number of consecutive variances 308-1 to 308-Q falls below the predetermined threshold value. That is, for instance, each of the rolling number of consecutive variances 308-1 to 308-Q may include a certain number of the variances 308-1 to 308-Q, e.g., three, five, seven, nine, or the like. In the example shown in FIG. 3, the certain rolling number of consecutive variances 308-1 to 308-Q may include three consecutive variances and thus, a first certain number may include the variances 308-1 to 308-3, a second certain number may include the variances 308-2 to 308-4, and so forth. In addition, the processor 102 may determine whether each of the sets of consecutive variances 308-1 to 308-Q either falls below or exceeds 310-1 to 310-R the predetermined threshold value. According to examples, the processor 102 may stop the reclamation operation based on any of the sets of consecutive variances 308-1 to 308-Q falling below the predetermined threshold value. For instance, the processor 102 may stop the reclamation operation as soon as the processor 102 determines that a set of consecutive variances 308-1 to 308-Q falls below the predetermined threshold value such that the processor 102 may minimize the amount of time that the reclamation system 202 is activated.

According to examples in which the 3D fabrication system 200 includes the second hopper 210 and the second sensor 214 as discussed herein, the processor 102 may sum the measurement values 220, 222 detected by the first sensor 212 and the second sensor 214 at multiple points in time. That is, the processor 102 may sum the measurement values 220, 222 detected at each of the multiple points in time. In addition, the processor 102 may calculate the variances among the summed measurement values 220, 222 and may determine whether a calculated variance of the calculated variances among the summed measurement values 220, 222 falls below the predetermined threshold value. The processor 102 may further stop the reclamation operation based on a determination that the calculated variance falls below the predetermined threshold value.

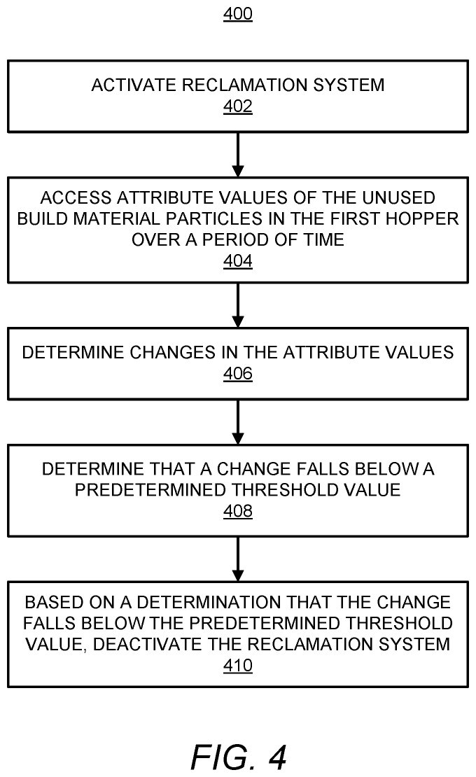

Various manners in which the processor 102 may operate are discussed in greater detail with respect to the method 400 depicted in FIG. 4. Particularly, FIG. 4 depicts a flow diagram of an example method 400 for controlling an operation of a reclamation system 202 in a 3D fabrication system 200. It should be understood that the method 400 depicted in FIG. 4 may include additional operations and that some of the operations described herein may be removed and/or modified without departing from the scope of the method 400. The description of the method 400 is made with reference to the features depicted in FIGS. 1-3 for purposes of illustration.

At block 402, the processor 102 may activate a reclamation system 202 to reclaim unused build material particles 204 from a build chamber 206 into a first hopper 208. The build chamber 206 may include an opening through which the unused build material particles 204 may be removed from the build chamber 206. As discussed herein, the reclamation system 202 may include a vibration motor to cause the build chamber 206 and/or a platform in the build chamber 206 to vibrate, which may loosen the unused build material particles 204 for better flow. In addition, the reclamation system 202 may include a pump that may force air from an interior of the build chamber 206 to flow toward the first hopper 208. As such, for instance, the processor 102 may activate the vibration motor and/or pump to begin a reclamation operation of the unused build material particles 204.

At block 404, the processor 102 may access attribute values (e.g., the first values 220) of the unused build material particles 204 in the first hopper 208 over a period of time. For instance, the first sensor 212 may detect the first attribute, e.g., the weight of the first hopper 208, the pressure inside the first hopper 208, and/or the like, over the period of time, e.g., from when the reclamation system 202 was activated to a current time, and may send the detected first attribute values 220 to the processor 102. The first sensor 212 may also continue to detect the first attribute and may continue to send the detected first attribute values 220 to the processor 102.

In examples in which the unused build material particles 204 are to be moved from the first hopper 208 to the second hopper 210, the processor 102 may also access attribute values (e.g., the second values 222) of the unused build material particles 204 in the second hopper 210 over the period of time. For instance, the second sensor 214 may detect the second attribute, e.g., weight of the second hopper 210, pressure inside the second hopper 210, and/or the like, over the period of time, e.g., from when the reclamation system 202 was activated to a current time, and may send the detected second attribute values 222 to the processor 102. The second sensor 214 may also continue to detect the second attribute and may continue to send the detected second attribute values 222 to the processor 102. In these examples, the processor 102 may sum the accessed attribute values 220, 222 of the unused build material particles 204 in the first hopper 208 and the second hopper 210 for respective periods of time. Thus, for instance, the processor 102 may sum the attribute values 220, 222 detected at a first instance in time, sum the attribute values 220, 222 detected at a second instance in time, and so forth.

At block 404, the processor 102 may determine changes in the first attribute values 220 (and/or sums of the first attribute values 220 and the second attribute values 222) over the period of time. That is, the processor 102 may determine variances in the first attribute values 220 (and/or the second attribute values 222) over the period of time as discussed herein. In other words, the processor 102 may determine the extent of changes in the first attribute values 220 (and/or the second attribute values 222) over the period of time. As discussed herein, the first attribute values 220 (and the second attribute values 222) may increase as the unused build material particles 204 are moved from the build chamber 206 to the first hopper 208 and the second hopper 210.

At block 406, the processor 102 may determine that a change in the attribute values 220 (and/or a change in a sum of the attribute values with the second attribute values 222) falls below a predetermined threshold value. According to examples, the processor 102 may perform a filtering process on the accessed attribute values 220 (and the second attribute values 222) to reduce noise as discussed above with respect to FIG. 3.

In addition, at block 408, based on the determination that the change in the attribute values 220 falls below the predetermined threshold value, the processor 102 may deactivate the reclamation system 202. In some examples, and as discussed herein, the processor 102 may deactivate the reclamation system 202 based on a determination that a certain number of consecutive changes in the attribute values 220 falls below the predetermined threshold value. For instance, the processor 102 may deactivate the reclamation system 202 based on a determination that three consecutive changes fall below the predetermined threshold value.

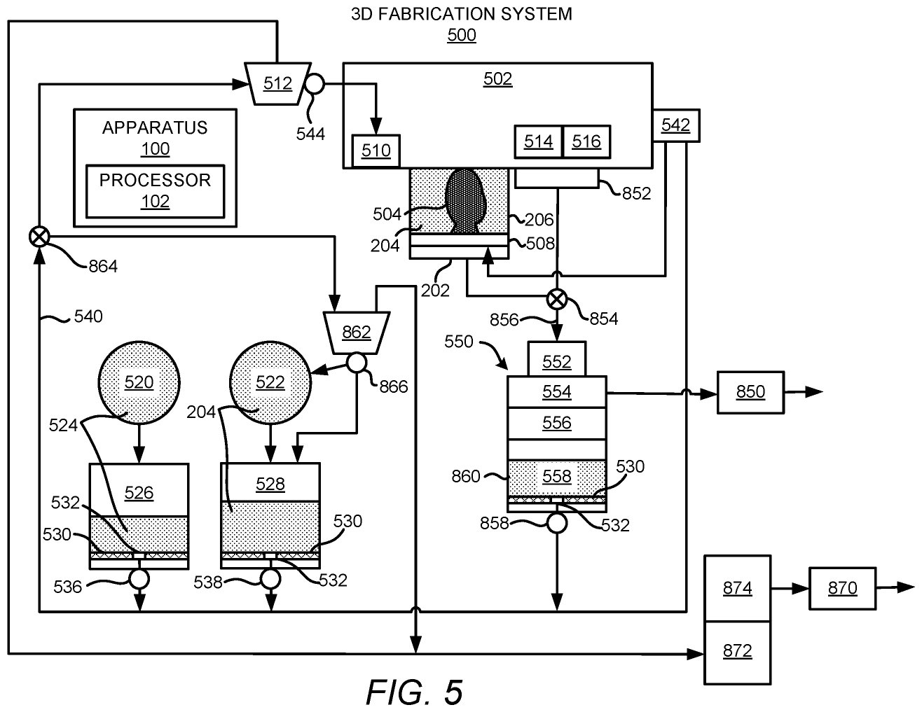

With reference now to FIG. 5, there is shown a block diagram of an example 3D fabrication system 500 in which the apparatus 100 and the processor 102 depicted in FIGS. 1 and 2 may control activation and deactivation of a reclamation system 202 of the 3D fabrication system 500. It should be understood that the 3D fabrication system 500 depicted in FIG. 5 may include additional components and that some of the components described herein may be removed and/or modified without departing from a scope of the 3D fabrication system 500 disclosed herein. The description of FIG. 5 is made with reference to the elements shown in FIGS. 1-4 for purposes of illustration and not of limitation.

As shown, the 3D fabrication system 500 may include a build chamber 502 within which a 3D object 504 may be fabricated from build material particles 204 provided in respective layers in a build chamber 206. Particularly, a movable build platform 508 may be provided in the build chamber 206 and may be moved downward as the 3D object 504 is formed in successive layers of the build material particles 204. An upper hopper 512, which may include a cyclone separator, may supply a spreader 510 with the build material particles 204. The spreader 510 may move across the build chamber 206 to form the successive layers of the build material particles 204 received from the upper hopper 512.

Forming components 514 may be implemented to deliver an agent onto selected locations on the layers of build material particles 204 to form sections of the 3D object 504 in the successive layers. The forming components 514 may include an agent delivery device or multiple agent delivery devices, e.g., printheads, fluid delivery devices, etc. Thus, although the forming components 514 have been depicted as a single element, it should be understood that the forming components 514 may represent multiple elements. An energy emitting mechanism 516 that may apply energy onto the layers of build material particles 204 to form the sections of the 3D object 504 may also be provided in the build chamber 502. The energy emitting mechanism 516 may be a heater, a light source, and/or the like.

According to examples, the agent may be a fusing agent that may enhance absorption of heat from the energy emitting mechanism 516 to heat the build material particles 204 to a temperature that is sufficient to cause the build material particles 204 upon which the agent has been deposited to melt. In addition, the heating mechanism 516 may apply heat, e.g., in the form of heat and/or light, at a level that may cause the build material particles 204 upon which the agent has been applied to melt without causing the build material particles 204 upon which the agent has not been applied to melt. In other examples, the agent may be a chemical binder that may cause the build material particles 204 upon which the agent is deposited to bind together to form part of a 3D object when the agent solidifies. In these examples, the heating mechanism 516 may be implemented to dry the agent or may be omitted in instances in which the chemical binder binds the build material particles 204 in the absence of additional heat.

According to one example, the agent may be an ink-type formulation including carbon black, such as, for example, the fusing agent formulation commercially known as V1Q60A “HP fusing agent” available from HP Inc. In one example, such a fusing agent may additionally include an infra-red light absorber. In one example such fusing agent may additionally include a near infra-red light absorber. In one example, such a fusing agent may additionally include a visible light absorber. In one example, such a fusing agent may additionally include a UV light absorber. Examples of fusing agents including visible light enhancers are dye based colored ink and pigment based colored ink, such as inks commercially known as CE039A and CE042A available from HP Inc. According to one example, the 3D fabrication system 500 may additionally use a detailing agent. According to one example, a suitable detailing agent may be a formulation commercially known as V1Q61A “HP detailing agent” available from HP Inc.

According to another example, the agent may be a thermally curable binder that may be cured through receipt of energy from the energy emitting mechanism 516. When cured, the agent may cause the build material particles 204 to which the agent has been deposited to be bound together to form part of the 3D object 504.

The build material particles 204 may include any suitable material for use in forming 3D objects 504. The build material particles 204 may include, for instance, a polymer, a plastic, a ceramic, a nylon, a metal, combinations thereof, or the like, and may be in the form of a powder or a powder-like material. Additionally, the build material particles 204 may be formed to have dimensions, e.g., widths, diameters, or the like, that are generally between about 5 μm and about 100 μm. In other examples, the particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition or in other examples, the particles may be partially transparent or opaque. According to one example, a suitable build material may be PA12 build material commercially known as V1R10A “HP PA12” available from HP Inc.

The forming components 514 may supply multiple types of agents onto the layers of build material particles 204. The multiple types of agents may include agents having different properties with respect to each other. In this regard, the forming components 514 may be controlled to supply the agent or a combination of agents that may result in the fabrication of the 3D object 504 having certain features. By way of particular example, the multiple types of agents may be differently colored inks and the forming components 514 may deposit an agent or a combination of agents onto build material particles 204 to form the 3D object 504 to have a particular color.

The processor 102 may control various operations in the 3D fabrication system 500 including the spreader 510, the hopper 512, and the forming components 514. The processor 102 may implement operations to control the forming components 514 to form the 3D object 504 in a volume of build material particles 204 contained in the build chamber 206. Although particular reference is made to the processor 102 as controlling the various operations of the components of the 3D fabrication system 500, it should be understood that another processor (not shown) may control the various operations in the components of the 3D fabrication system 500 without departing from a scope of the 3D fabrication system 500.

The build material particles 204 used to form the 3D object 504 may be composed of particulate material from a fresh supply 520 of build material particles, build material particles from a recycled supply 522 of build material particles, or a mixture thereof. The fresh supply 520 may represent a removable container that contains build material particles 524 that has not undergone any 3D object formation cycles, e.g. is fresh. The recycled supply 522 may represent a removable container that contains build material particles 204 that has undergone at least one 3D object formation cycle and may contain particles that have undergone different numbers of 3D object formation cycles with respect to each other.

As shown, the build material particles 524 in the fresh supply 520 may be provided into a fresh material hopper 526 and the build material particles 204 in the recycled supply 522 may be provided into a recycled material hopper 528. The recycled supply 522 or the recycled material hopper 528 may be equivalent to the second hopper 210 discussed herein. Additionally, the build material particles 524, 204 in either or both of the fresh material hopper 526 and the recycled material hopper 528 may be supplied to the upper hopper 512. The build material particles 524, 204 may be provided into the hoppers 526, 528 from the respective supplies 520, 522 prior to implementing a print job to ensure that there are sufficient build material particles 524, 204 available to complete the print job. The hoppers 526 and/or 528 may include a conditioning assembly, e.g., a porous membrane 530 having a drain opening 532, to fluidize build material particles 524, 204 contained in the hoppers 526 and/or 528.

Generally speaking, the processor 102 may control the mixture or ratio of the fresh particles and recycled particles that are supplied to the upper hopper 512. The ratio may depend upon the type of 3D object 504 being formed. For instance, a higher fresh particle to recycled particle ratio, e.g., up to a 100 percent fresh particle composition, may be supplied when the 3D object 504 is to have a higher quality, to have thinner sections, have higher tolerance requirements, or the like. Conversely, a lower fresh particle to recycled particle ratio, e.g., up to a 100 percent recycled particle composition, may be supplied when the 3D object 504 is to have a lower quality as may occur when the 3D object 504 is a test piece or a non-production piece, when the 3D object 504 is to have lower tolerance requirements, or the like. The ratio may be user-defined, may be based upon a particular print job, may be based upon a print setting of the 3D fabrication system 500, and/or the like.

In any regard, the processor 102 may control the ratio of the fresh and the recycled particles supplied to the upper hopper 512 through control of respective feeders 536, 538. A first feeder 536 may be positioned to supply fresh build material particles 524 to a supply line 540 from the fresh material hopper 526 and the second feeder 538 may be positioned to supply recycled build material particles 204 to the supply line 540 from the recycled material hopper 528. The first feeder 536 and the second feeder 538 may be rotary airlocks that may regulate the flow of the build material particles 524, 204 from the respective hoppers 526, 528 to the feed line 540 for delivery to the upper hopper 512. The feed line 540 may also be supplied with air from an input device 542 to assist in the flow of the build material particles 524, 204 from the hoppers 526, 528 to the upper hopper 512.

A third feeder 544, which may also be a rotary airlock (which allows forward-flow of powder and restricts back-flow of air), may be positioned along a supply line from the upper hopper 512 to the spreader 510. The upper hopper 512 may include a level sensor (not shown) that may detect the level of build material particles 524, 204 contained in the upper hopper 512. The processor 102 may determine the level of the build material particles 524, 204 contained in the upper hopper 512 from the detected level and may control the feeders 536, 538 to supply additional build material particles 524, 204 in a particular ratio when the processor 102 determines that the level of the build material particles 524, 204 in the upper hopper 512 is below a threshold level, e.g., to ensure that there is a sufficient amount of build material particles 524, 204 to form a layer of build material particles 524, 204 having a certain thickness during a next spreader 510 pass.

The 3D fabrication system 500 may also include a collection mechanism 550, which may include a blow box 552, a filter 554, a sieve 556, and a reclaimed material hopper 558. The reclaimed material hopper 558 may be equivalent to the first hopper 208 discussed herein. Thus, for instance, activation of the collection mechanism 550 may cause unused build material particles 204 in the build chamber 206 to be moved into the reclaimed material hopper 558 during a reclamation operation. This is, for instance, activation of the reclamation system 202 may cause a pump 551, which may be a blower, to cause air to flow from the build chamber 206 and through the collection mechanism 550 to collect the unused build material particles 204 into the reclaimed material hopper 558. The collection mechanism 550 may also reclaim incidental build material particles 204 from a location adjacent to the build chamber 206 as shown in FIG. 5. Particularly, following formation of the 3D object 504, unused build material particles 204 may remain in powder form and the collection mechanism 550 may reclaim the build material particles 204 that were not used to form the 3D object 504. In addition, the unused build material particles 204 may be separated from the 3D object 504 through application of a vacuum force inside the build chamber 206. The vibration motor in the reclamation system 202 may also be vibrated to separate the unused build material particles 204 from the 3D object 504.

The unused build material particles 204 in the build chamber 206 may be sucked into the blow box 552 and through the filter 554 and the sieve 556 before being collected in the reclaimed material hopper 558. Additionally, during spreading of the build material particles 204 to form layers in the build chamber 206, e.g., as the spreader 510 moves across the build chamber 206, unused build material particles 204 may collect around a perimeter of the build chamber 206. As shown, a perimeter vacuum 560 may be provided to collect the unused build material particles 204 around the perimeter, such that the unused build material particles 204 may be supplied to the collection mechanism 550. A valve 562, such as an electronically controllable three-way valve, may be provided along a feed line 564 from the build chamber 206 and the perimeter vacuum 560. In examples, the processor 102 may manipulate the valve 562 such that unused build material particles 204 may flow from the perimeter vacuum 560 during formation of the 3D object 504 and flow from the build chamber 206 following formation of the 3D object 504, e.g., during a reclamation operation.

A fourth feeder 566, which may also be a rotary airlock, may be provided to feed the reclaimed build material particles 204 contained in the reclaimed material hopper 558 to the upper hopper 512 and/or to a lower hopper 568. The fourth feeder 566 may feed the reclaimed build material particles 204 through the feed line 540. The reclaimed material hopper 558 may include a conditioning assembly to condition unused build material particles 204, e.g., a porous membrane 530 having a drain opening 532 through which the reclaimed build material particles 204 may be supplied out of the reclaimed material hopper 558.

A valve 570, which may be an electronic three-way valve, may be a three-port, two-state valve in which materials may flow in one of two directions, may be provided along the feed line 540 and may direct the reclaimed build material particles 204 to the upper hopper 512 or may divert the reclaimed build material particles 204 to the lower hopper 568. The processor 102 may also manipulate the valve 570 to control whether the reclaimed build material particles 204 are supplied to the upper hopper 512 or the lower hopper 568. In some examples, the processor 102 may make this determination based upon the ratio of fresh and recycled build material particles 524, 204 that is to be used to form the 3D object 504.

A fifth feeder 572, which may also be a rotary airlock, may be provided to feed the reclaimed build material particles 204 contained in the lower hopper 568 to the recycled supply 522 and/or the recycled material hopper 528. The processor 102 may control the fifth feeder 572 to feed the reclaimed build material particles 204 into the recycled supply 522 in instances in which the reclaimed build material particles 204 are not to be used in a current build. In addition, the processor 102 may control the fifth feeder 572 to feed the reclaimed build material particles 204 into the recycled material hopper 528 in instances in which the reclaimed build material particles 204 are to be used in a current or a next build. In any regard, the reclaimed build material particles 204 may be moved from the reclaimed material hopper 558 and into the recycled supply 522 and/or the recycled material hopper 528 in instances in which the reclaimed material hopper 558 may be of insufficient size to handle all of the unused build material particles 204 from the build chamber 206.

The 3D fabrication system 500 may also include a blower 574 that may create suction to enhance airflow through the lines in the 3D fabrication system 500. The airflow may flow to a filter box 576 and a filter 576 that may remove particulates from the airflow from the upper hopper 512 and the lower hopper 568 prior to the airflow being exhausted from the 3D fabrication system 500. In other words, the blower 574, filter box 576, and filter 578 may represent parts of the outlets of the upper hopper 512 and the lower hopper 568 and may collect particulates that were not removed from the airflow in cyclone separators connected to the upper and/or lower hoppers 512 and 568.

Although not shown in FIG. 5, the apparatus 100 may include an interface through which the processor 102 may communicate instructions to a plurality of components contained in the 3D fabrication system 500. The interface may be any suitable hardware and/or software through which the processor 102 may communicate the instructions. In any regard, the processor 102 may implement control of the reclamation system 202 based on the detected variances in the attribute values as discussed above. In addition, the processor 102 may sum attribute values detected at the reclaimed material hopper 558, the recycled supply 522, and the recycled material hopper 528 and may stop the reclamation system 202 based on the summed attribute values.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
access a plurality of measurement values corresponding to build material particles reclaimed from a build chamber during a period of time in which a reclamation operation is performed, the plurality of measurement values being determined at a first hopper of the reclaimed build material particles as the build material particles are reclaimed from the build chamber and received into the first hopper;
calculate variances among the plurality of measurement values;
determine whether a variance of the calculated variances falls below a predetermined threshold value; and
based on a determination that the calculated variance falls below the predetermined threshold value, stop the reclamation operation.

2. The apparatus of claim 1, wherein the plurality of measurement values are determined continuously over the period of time, and wherein the instructions are further to cause the processor to:
access the plurality of measurement values as the plurality of measurement values are determined continuously over the period of time; and
calculate the variances as the plurality of measurement values are accessed over the period of time.

3. The apparatus of claim 1, wherein the reclamation operation comprises activation of a vibration motor to cause the build chamber to vibrate and a pump to draw air and the reclaimed build material particles from the build chamber, and wherein the instructions are further to cause the processor to:
deactivate the vibration motor and the pump based on the determination that the calculated variance falls below the predetermined threshold value to stop the reclamation operation.

4. The apparatus of claim 1, wherein the instructions are further to cause the processor to:
determine whether a certain number of consecutive ones of the calculated variances falls below the predetermined threshold value; and
stop the reclamation operation based on a determination that the certain number of consecutive ones of the calculated variances falls below the predetermined threshold value.

5. The apparatus of claim 1, wherein the instructions are further to cause the processor to:
perform a filtering process on the plurality of measurement values to reduce noise in the plurality of measurement values.

6. The apparatus of claim 1, wherein the instructions are further to cause the processor to:
for each of a rolling set of the plurality of measurement values, select a measurement value having a predefined rank among the rolling set;
for each of a rolling set of measurement values having the predefined rank, determine an average;
for each of a rolling set of averages, determine a variance; and
for each of the determined variances, determine whether the variance falls below the predetermined threshold value.

7. The apparatus of claim 1, wherein the plurality of measurement values are determined at the first hopper and at a second hopper, and wherein the instructions are further to cause the processor to:
sum the plurality of measurement values determined at the first hopper and the second hopper at multiple points in time;
calculate variances among the summed plurality of measurement values; and
determine whether a calculated variance of the calculated variances among the summed plurality of measurement values falls below the predetermined threshold value; and
based on a determination that the calculated variance falls below the predetermined threshold value, stop the reclamation operation.

8. A three dimensional (3D) fabrication system comprising:
a build chamber within which build material particles are to be formed into 3D objects;
a reclamation system to reclaim unused build material particles from the build chamber;
a first hopper to receive unused build material particles reclaimed from the build chamber;
a first sensor to detect an attribute value of the unused build material particles in the first hopper;
a processor to:
activate the reclamation system;
access detected attribute values of the unused build material particles in the first hopper over a period of time;
calculate a variance among a respective set of the detected attribute values;
determine whether the calculated variance falls below a predetermined threshold value; and
based on a determination that the calculated variance falls below the predetermined threshold value, deactivate the reclamation system.

9. The 3D fabrication system of claim 8, further comprising:
a second hopper to receive the unused build material particles from the first hopper;
a second sensor to detect an attribute value of the unused build material particles in the second hopper;
wherein the processor is further to:
access detected attribute values of the unused build material particles in the second hopper over the period of time;
sum the detected attribute values of the unused build material particles in the first hopper and the second hopper for respective periods of time;
calculate variances among the summed detected attribute values;
determine whether a calculated variance of the calculated variances among the summed detected attribute values falls below the predetermined threshold value; and
based on a determination that the calculated variance falls below the predetermined threshold value, deactivate the reclamation system.

10. The 3D fabrication system of claim 9, wherein the unused build material particles are to be moved from the first hopper to the second hopper following deactivation of the reclamation system.

11. The 3D fabrication system of claim 8, wherein the reclamation system includes a vibration motor to cause the build chamber to vibrate and a pump to draw air and the unused build material particles from the build chamber, and wherein the processor is further to:
activate the vibration motor and the pump to activate the reclamation system; and
deactivate the vibration motor and the pump to deactivate the reclamation system.

12. The 3D fabrication system of claim 8, wherein the processor is further to:
for each of a rolling set of the detected attribute values, select an attribute value having a predefined rank among the rolling set;
for each of a rolling set of attribute values having the predefined rank, determine an average;
for each of a rolling set of averages, determine a variance; and
for each of the determined variances, determine whether the variance falls below the predetermined threshold value.

13. A method comprising:
activating, by a processor, a reclamation system to reclaim unused build material particles from a build chamber into a first hopper;
accessing, by the processor, attribute values of the unused build material particles in the first hopper over a period of time;
determining, by the processor, changes in the attribute values over the period of time;
determining, by the processor, that a change in the attribute values falls below a predetermined threshold value; and
based on the determination that the change in the attribute values falls below the predetermined threshold value, deactivating, by the processor, the reclamation system.

14. The method of claim 13, further comprising:
accessing attribute values of the unused build material particles in a second hopper over the period of time, wherein the second hopper is to receive the unused build material particles from the first hopper;
summing the accessed attribute values of the unused build material particles in the first hopper and the second hopper for respective periods of time;
determining changes in the summed attribute values over the respective periods of time;
determining whether a determined change of the determined changes among the summed attribute values falls below the predetermined threshold value; and
based on a determination that the determined change falls below the predetermined threshold value, deactivating the reclamation system.

15. The method of claim 13, further comprising:
performing a filtering process on the accessed attribute values to reduce noise in the accessed attribute values.
